(19) United States
(12) Patent Application Publication
(10) Pub. No.: US 2011/0208477 A1
(43) Pub. Date: Aug. 25, 2011

(54) MEASURING METHOD OF PATTERN DIMENSION AND SCANNING ELECTRON MICROSCOPE USING SAME

(76) Inventors: Keiichiro Hitomi, Delmar, NY (US); Yoshinori Nakayama, Sayama (JP)

(21) Appl. No.: 13/126,768

(22) PCT Filed: Oct. 28, 2009
(86) PCT No.: PCT/JP2009/005695

§ 371 Date: Apr. 29, 2011

(30) Foreign Application Priority Data
Nov. 5, 2008 (JP) 2008-284560

(51) Int. Cl. G01B 15/04; G06F 15/00

(52) U.S. Cl. 702/167

(57) ABSTRACT

Provided is a technology of performing more highly accurate semiconductor inspection by detecting a pattern edge which does not contribute as a mask in an etching step and measuring a pattern without including such edge at the time of calculating dimensions. Since a pattern portion having a protruding shape is to be removed at the time of etching, a scanning electron microscope image is acquired such that the protruding edge not functioning as a mask is to be excluded at the time of calculating dimensions in pattern inspection. Then, the shape of the pattern edge is calculated, the portion of the protruding edge is corrected, and pattern dimensions mainly obtained from recessed edges are calculated.

### TECHNICAL FIELD

The present invention relates to pattern linewidth measurement and a scanning electron microscope using it.

### BACKGROUND ART

Semiconductor devices are manufactured mainly by a lithography process and an etching process. The lithography process refers to a process in which: light having a certain wavelength is applied to a photosensitive material (hereafter, referred to as resist) applied to a substrate; and the substrate is immersed in developer to form a resist micropattern thereover. It is designated as etching process to process an underlayer by dry etching using a resist micropattern formed by this lithography process as a mask. The masks used in etching processes are not only resist and those designated as hard mask of silicon oxide material, silicon nitride material, or the like are also used. An optimum mask to use is determined according to the process. The microminiaturization of semiconductor devices has been driven by the advancement of the lithography process and the etching process. Especially, in lithography processes, it has become possible to form finer resist patterns owing to reduction of the wavelengths of exposure light sources. An exposure light source presently predominantly used is ArF excimer laser light (wavelength: 193 nm). In conjunction with reduction of the wavelengths of exposure light sources, the resist materials are also largely changed. This is intended to address such problems as absorption of exposure wavelength and enhance efficiency, including the enhancement of sensitivity. The photosensitive material used in ArF lithography is designated as ArF resist and is indispensable to ArF lithography. For years to come, the lithography technology (ArF lithography) using this ArF excimer laser light will be used in the manufacture of semiconductor devices as a cutting-edge technology.

A resist micropattern formed by a lithography process has a great influence on the performance of semiconductor devices obtained thereafter; therefore, highly accurate dimensional inspection is required. In dimensional inspection, consequently, a critical dimension scanning electron microscope (CD-SEM) having a high spatial resolution is used. The CD-SEM is used to carry out various inspections, resist pattern linewidth and form assessment. Especially, in recent years, attention has been paid not only to pattern linewidth but also to fluctuation in its form, such as line edge roughness (LER) and line width roughness (LWR). As described in Patent Document 1 and Non-patent Document 1, studies have been actively conducted into measurement methods and suppression methods for roughness.

To measure roughness as a distribution index value of patterns, it is necessary to detect the edge of a pattern at multiple points and measure the distribution thereof. For example, in case of a pattern having a one-dimensional length like the gate pattern illustrated in FIG. 1, multiple brightness profiles are generated with respect to the direction crossing the pattern. In FIG. 1, N brightness profiles are generated. Edge positions are calculated from the individual brightness profiles using a certain algorithm. The algorithm used in the edge position calculation is described in detail in Patent Document 2. In case of a pattern having a length both in the X direction and in the Y direction like the contact hole illustrated in FIG. 2, first, the pattern center is found. To fine the pattern center, pattern matching or the like may be used. After the pattern center is found, multiple brightness profiles taken from the pattern center in the radial direction are generated at intervals of several degrees. In FIG. 2, N brightness profiles are generated at intervals of 360/N degrees. Similarly to the case of the gate pattern, edge positions are calculated from the individual brightness profiles using a certain algorithm. In case of the contact hole illustrated in FIG. 2, the brightness profile may be largely changed depending on the center position. Consequently, edge position calculation is carried out by calculating back the pattern center from each of the calculated edge positions and calculating a line profile from the recalculated pattern centers again. Conventionally, pattern linewidths and edge position distribution index values are determined from the multiple edge positions thus determined.

The cross section form of a resist pattern formed by a lithography process is largely changed by the focus of an aligner or deviation in light exposure as shown in Patent Document 3. As shown in Non-patent Document 2, it is known that there are microscopic asperities in the side walls of resist patterns. These microscopic asperities are shaved off by the collision of ions during an etching process and it is presumed that ultimately, they are rarely transferred to an underlayer.

### RELATED ART DOCUMENTS

### Patent Document

Patent Document 1: Japanese Patent Application Laid-Open Publication No. 2004-251743
Patent Document 2: Japanese Patent Application Laid-Open Publication No. 2007-120968
Patent Document 3: Japanese Patent Application No. 2007-98324

### Non-Patent Document

Non-patent Document 1: “Japanese Journal of Applied Physics Part 1,” 2005, vol. 44, pp. 5575-5580
Non-patent Document 2: “IEEE Transactions on Semiconductor Manufacturing,” 2007, vol. 20, pp. 232-238

### DISCLOSURE OF THE INVENTION

### Problems to be Solved by the Invention

When the edge form of a resist pattern is changed, how the resist pattern is transferred to an underlayer by an etching process is changed. Therefore, resist pattern linewidth and the pattern linewidth of a processed film after etching do not correspond to each other one-on-one unless the dimensions of a part to be transferred to the underlayer are measured when the linewidth of the resist pattern is measured. Up to this point, the pattern linewidth has been defined as the mean values of multiple obtained edge positions. However, this technique does not taken into account whether or not some part is transferred to an underlayer. As a result, it is suspected that: even though resist patterns are identical in linewidth, their transferred patterns differ because the resist is shaved off by the subsequent etching process and a difference in linewidth after etching is produced from pattern to pattern. Especially, it is supposed that resist is largely shaved off from projections of the above-mentioned asperities in edge roughness by the collision of ions in the etching process while it is not shaved off from depressions so much. What is important for semiconductor devices is the dimensions of processed films after etching and the resist pattern linewidth is a means for estimating the dimensions of processed films. Because of the above-mentioned reason, dimensions after etching cannot be accurately estimated from resist dimensions by conventional inspection techniques. That is, it is supposed that it is insufficient to inspect semiconductor devices to just compare the mean values of edge position or the distribution of edge positions as conventional.

Consequently, it is an object of the invention to provide a technology for more accurately conducting semiconductor inspection by carrying out pattern measurement so that: any pattern edge that does not contribute as a mask in an etching process is not detected and this edge is not included in linewidth calculation.

### Means of Solving the Problems

The object of the invention is achieved by providing the steps described below in a pattern linewidth measurement method including the steps of: scanning and applying an electron beam to an observation area in a sample placed over a stage and detecting a reflection electron or a secondary electron generated from the sample with a detector; using information on detected reflection electron intensity or secondary electron intensity to acquire a two-dimensional image of a pattern as the object of linewidth measurement placed in the observation area; and detecting the edge position of the pattern at multiple points in the pattern using the two-dimensional image to measure the linewidth of the pattern in the observation area. The steps provided in the pattern linewidth measurement method are the steps of: specifying a calculation method for the distribution index value of multiple edge positions detected at multiple points in the pattern; calculating a distribution index value corresponding to the specified calculation method; calculating the mean position of multiple edges; and calculating a pattern inspection index value from the calculated mean position of the edges and the distribution index value.

Or, the object of the invention is achieved by a scanning electron microscope including: a detector that scans and applies an electron beam to an observation area in a sample placed over a stage and detects a reflection electron or a secondary electron generated from the sample; a means for using information on the reflection electron intensity or secondary electron intensity detected at the detector to acquire a two-dimensional image of a pattern as the object of linewidth measurement placed in the observation area; and a means for using the two-dimensional image to detect the edge position of the pattern as the object of linewidth measurement placed in the observation area at multiple points in the pattern and thereby measuring the linewidth of the pattern in the observation area. This scanning electron microscope includes: calculation unit that carries out calculation based on information inputted from the scanning electron microscope or a display unit; the display unit that displays information inputted to the calculation unit or the result of calculation at the calculation unit; and a storage unit that holds the result of calculation at the calculation unit or information supplied to the calculation unit. The calculation unit includes: a pattern edge mean position calculation unit that calculates the mean position of edges of a pattern detected at multiple points; a distribution index value calculation unit that calculates a distribution index value determined according to a calculation method selected from among multiple calculation methods for the distribution index value of edge positions displayed on the display unit; and a pattern inspection index value calculation unit that calculates a pattern inspection index value based on the calculated mean position of the edges and the distribution index value.

The present inventors found the correlation between pattern form, especially, edge roughness and the pattern linewidth of a processed film. As mentioned above, projected portions of a pattern are shaved off during etching and thus they do not function as a mask. Therefore, these projected edges that do not function as a mask should be excluded from linewidth calculation in pattern inspection. In consideration of the foregoing, the following measure is taken in the invention: after a scanning electron microscopic image is acquired, pattern edge form is calculated and projected edge portions are corrected; and a pattern linewidth obtained mainly from depressed edges is calculated.

### Effects of the Invention

According to the invention, a pattern linewidth and the pattern linewidth of a processed film after etching can be brought into one-to-once correspondence with each other and more accurate semiconductor device inspection can be carried out.

### BRIEF DESCRIPTION OF THE DRAWINGS

FIG. 1 is a schematic diagram illustrating edge detection in a gate pattern.

FIG. 2 is a schematic diagram illustrating edge detection in a hole pattern.

FIG. 3 is a schematic diagram illustrating the configuration of a scanning electron microscope in an embodiment of the invention.

FIG. 4 is a flowchart of pattern linewidth measurement in a first embodiment.

FIG. 5 is a schematic diagram illustrating an example of hole pattern linewidth measurement.

FIG. 6 is a drawing illustrating a calculation flow taken when the standard deviation of edge positions is taken as distribution index value.

FIG. 7 is a drawing illustrating GUI used when a coefficient to be multiplied by a distribution index value is changed according to resist material.

FIG. 8 is a drawing illustrating GUI used in pattern linewidth measurement in the first embodiment.

FIG. 9 is a drawing illustrating a calculation flow taken when the following measure is taken: fluctuation in edge position is resolved into frequency components; an edge position is reconfigured from a specific frequency; and the standard deviation of the reconfigured edge positions is selected as distribution index value.

FIG. 10 is a drawing illustrating an edge position profile of a hole pattern and the result of frequency decomposition by DFT.

FIG. 11 is a drawing illustrating GUI used when a frequency for which a distribution index value is calculated is specified.

FIG. 12 is a flowchart illustrating a case where only edges whose edge position is negative relative to the mean of edge positions are used.

FIG. 13 is a flowchart illustrating a case where the result of exposure intensity distribution calculation is used to calculate a distribution index value.

FIG. 14 is a drawing illustrating the comparison of the result of exposure intensity distribution calculation and an actual pattern edge position.

FIG. 15 is a flowchart illustrating a case where a distribution index value is calculated from the result of shrink amount comparison.

FIG. 16 is a drawing illustrating a difference between an edge position measured according to this invention and an edge position measured by a conventional technique.

FIG. 17 is a drawing illustrating GUI used to display the result of measurement according to the invention.

FIG. 18 is a drawing illustrating variation due to a difference in the direction in which a brightness profile is generated.

### BEST MODE FOR CARRYING OUT THE INVENTION

Detailed description will be given to embodiments of the invention with reference to the drawings.

### First Embodiment

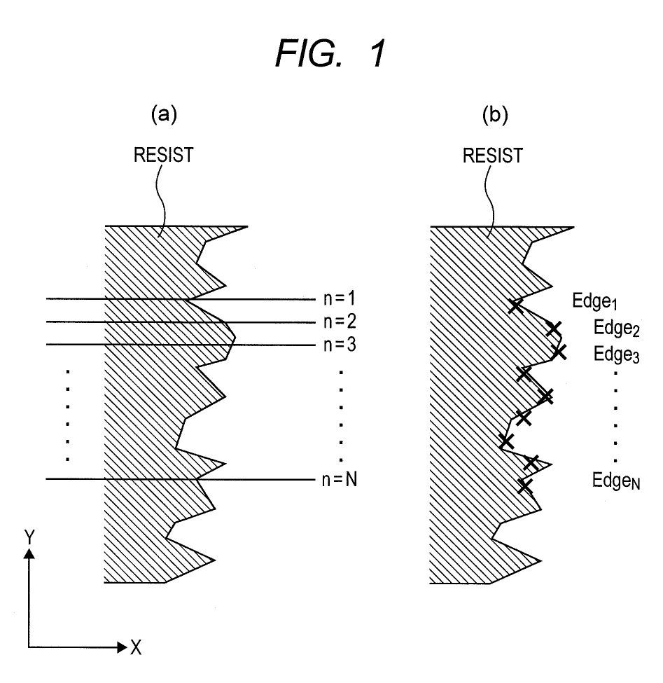

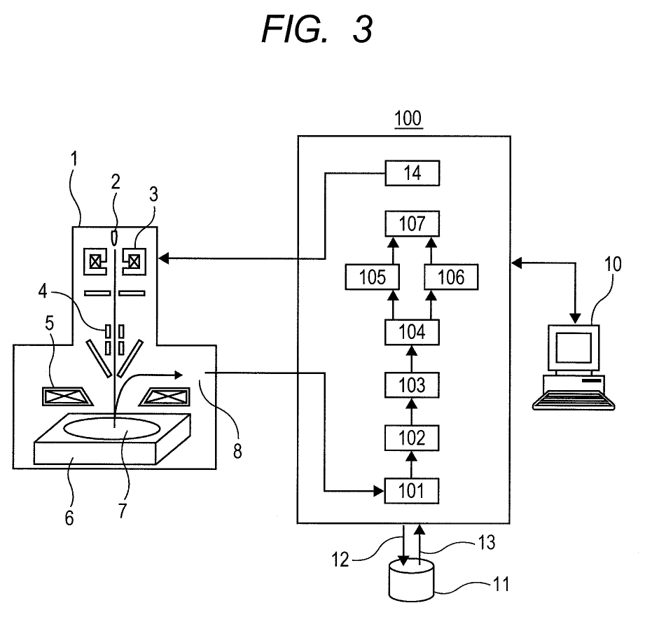

FIG. 3 is a schematic diagram of the configuration of an electron microscope of the invention. The invention is included: electron-optics 1 including an electron source 2 that emits electrons, a condensing lens 3 that converges an electron beam generated from the electron source 2, a deflector 4 that deflects the electron beam, an objective lens 5 that converges the electron beam so that it becomes the minimum spot on a sample, an observed sample 7, a stage 6 on which the observed sample 7 placed and which is moved to an observation area, and a detector 8 that detects a secondary electron or a reflection electron generated from the sample: a calculation unit 100 that processes obtained signal waveform to measure pattern linewidth; a display unit 10 for an operator to do input and display a scanning electron microscopic image; a storage unit 11 storing previous data; and an electron-optics control unit 14 that incorporates electron beam irradiation conditions and controls the electron-optics. Reference numeral 12 in FIG. 1 shows a flow of storing a result in the storage unit and the like and reference numeral 13 shows a flow of calling up data stored in the storage unit.

The calculation unit 100 includes: an image memory 101 that turns intensity information on a secondary electron or a reflection electron detected at the detector 8 into an image; a pattern form setting unit 102 for setting the form of a pattern to be observed based on input from a user; a distribution index value setting unit 103 for setting a calculation method for distribution index value based on input from a user; a pattern edge detection unit 104 that detects a pattern edge from a signal turned into an image at the image memory 101; a pattern edge mean position calculation unit 105 that calculates the mean value of the edge positions of an observed pattern from a detected pattern edge and a set value on the pattern form setting unit 102; a distribution index value calculation unit 106 that calculates the distribution index value of the edge positions of an observed pattern from a detected pattern edge and a set value on the distribution index value setting unit 103; and a pattern inspection index value calculation unit 107 that calculates a pattern inspection index value from calculation results from 105 and 106.

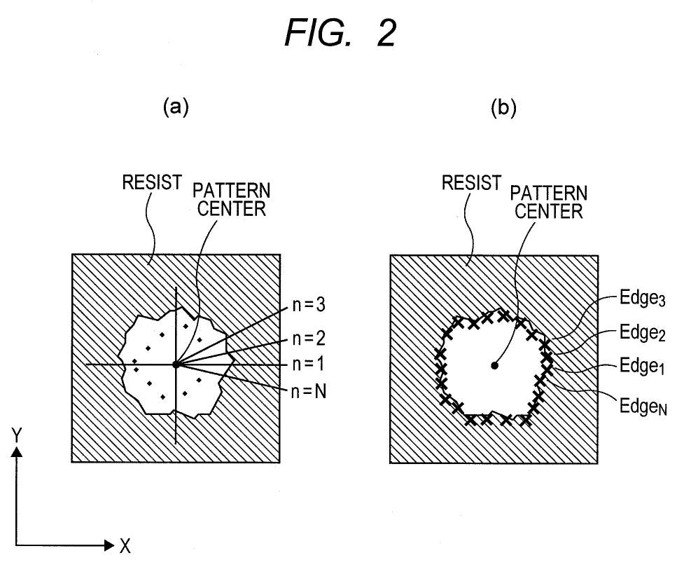

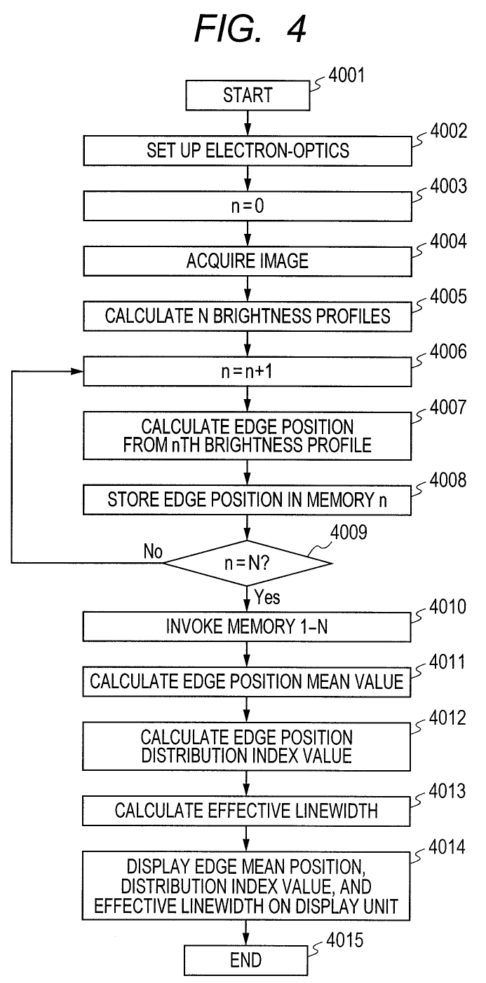

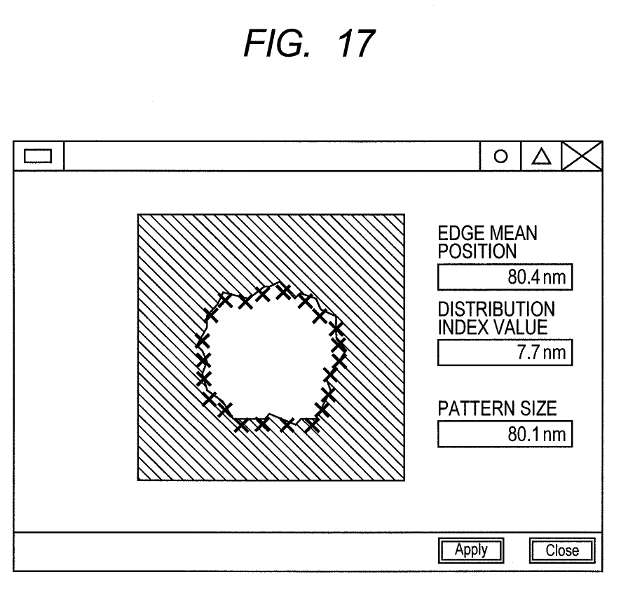

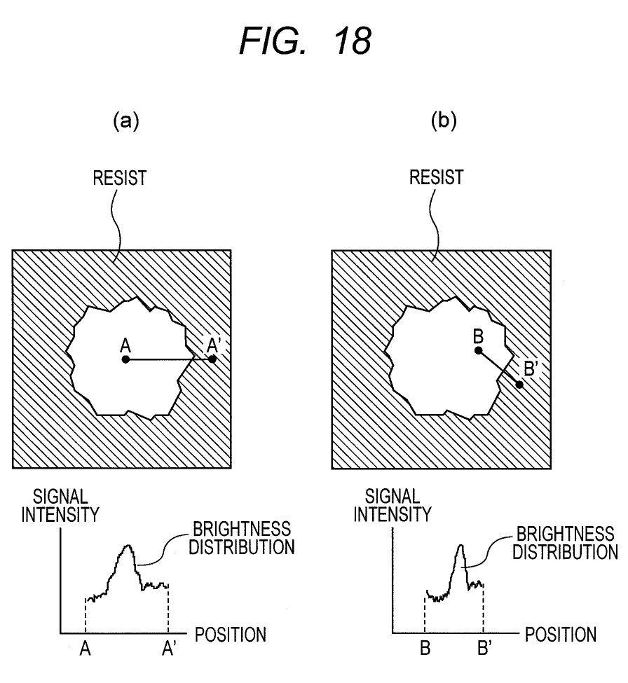

FIG. 4 is a flowchart of pattern linewidth measurement in the invention. First, a user sets electron microscope electron-optics used to pick up an image (Step 4002). Subsequently, the calculation unit 100 sets 0 to variable n to initialize the profile number under which an edge position is calculated (Step 4003). When the user actuates the electron microscope, the image memory 101 generates a two-dimensional image from intensity information on a secondary electron or a reflection electron generated from the sample (Step 4004). Using the above-mentioned method, N brightness profiles are calculated from the obtained two-dimensional image (Step 4005). The description of this embodiment is based on the assumption that the linewidth of such a contact hole pattern as illustrated in FIG. 2 is measured. In the brightness profile generation at Step 4005, it is necessary to detect the pattern center first. The detection of the pattern center and the like are as described above but they are not limited to this. The pattern edge detection unit 104 sequentially calculates edge positions from the N brightness profiles obtained at Step 4005. n is taken as the profile number under which an edge is calculated and n is specified at Step 4006. Using a certain algorithm, an edge position is calculated from the selected brightness profile (Step 4007). The image memory 101 stores the calculated edge position in memory n (Step 4008) and at Step 4009, the pattern edge detection unit 104 determines whether or not the edge position has been detected with respect to all the brightness profiles. When it is determined at Step 4009 that edge position detection has been all completed, the pattern edge detection unit 104 calls up all the detected edges (Step 4010). The pattern edge mean position calculation unit 105 calculates the mean position of edge positions from the multiple called edge positions (Step 4011). Further, the distribution index value calculation unit 106 calculates the distribution index value of edge positions from the called edge positions (Step 4012). The pattern inspection index value calculation unit 107 calculates a pattern linewidth that effectively works during etching from the mean position of multiple edge positions and the distribution index value obtained at Step 4011 and Step 4012 (Step 4013). The calculated edge mean position, distribution index value, and pattern linewidth are displayed on the display unit 10 in accordance with a command from the calculation unit 100 (Step 4014). The pattern linewidth measurement is terminated through the above-mentioned steps (Step 4015). FIG. 17 illustrates GUI that displays the calculated mean position of edge positions, distribution index value, and pattern linewidth at Step 4014.

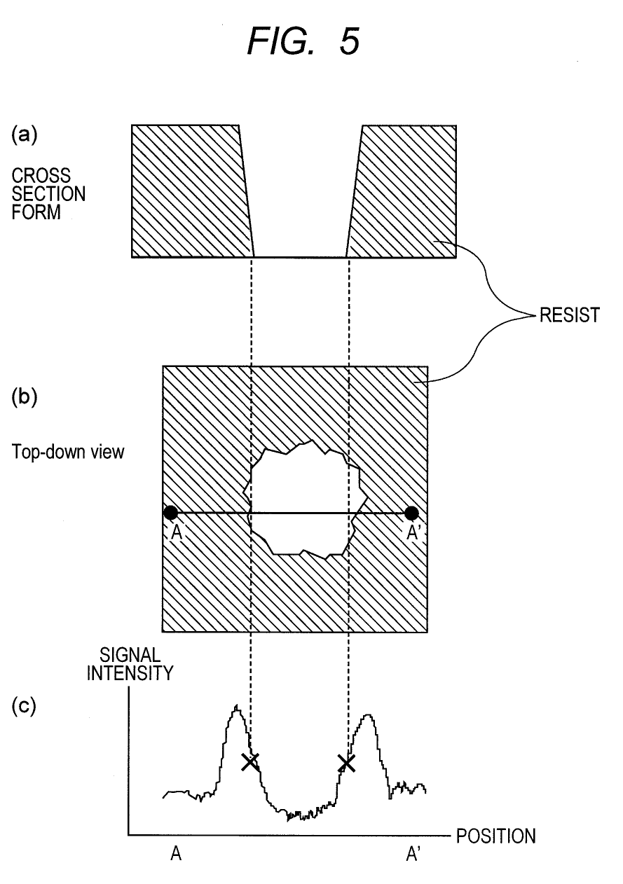

FIG. 5 illustrates the cross section form of the contact hole pattern illustrated in relation to this embodiment and signal intensity obtained therefrom. Such signal waveform as illustrated in FIG. 5 is obtained from the resist cross section form. In the electron microscope, a pattern linewidth is measured from this waveform. There are various algorithms used for pattern linewidth measurement and this invention is effective regardless of the algorithm used.

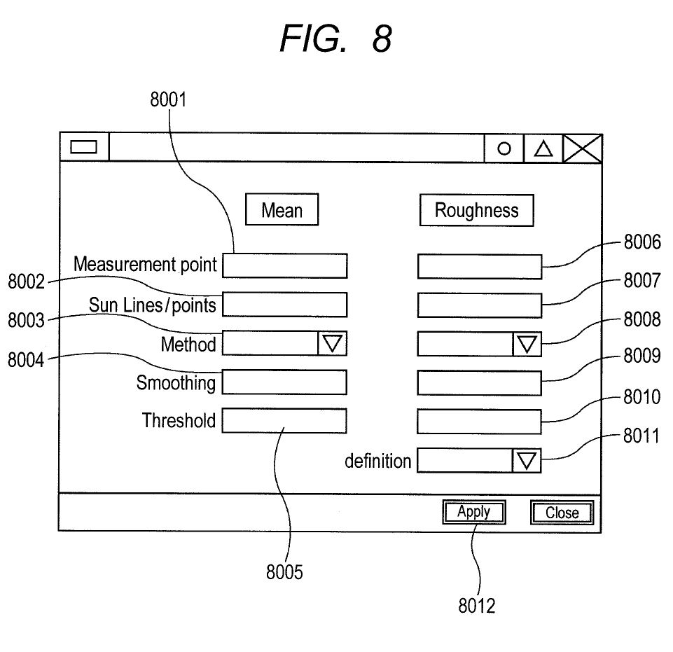

FIG. 8 illustrates GUI used in the pattern linewidth measurement in this embodiment. Reference numeral 8001 in FIG. 8 denotes an input field for the number of measurement points in an image. That is, it corresponds to N in this embodiment. Reference numeral 8002 denotes an input field for the number of pixels in the vertical direction added when signal waveform in one line is calculated. Reference numeral 8003 is a field for selecting an algorithm used in linewidth measurement. Examples of these linewidth measurement algorithms are threshold method, linear fitting method, and the like. Reference numeral 8004 denotes an input field for the size of a filter for smoothing the signal waveform in one line. Reference numeral 8005 denotes an input field for a threshold value that defines an edge when measurement is carried out by the threshold method. The above-mentioned reference numerals 8001 to 8005 denote fields for inputting a mean value of edge positions. Reference numeral 8006 denotes an input field for the number of measurement points used in distribution index value measurement. 8006 is set in conjunction with 8001. Reference numeral 8007 denotes an input field for the number of pixels in the vertical direction added when signal waveform in one line is calculated with a distribution index value. Reference numeral 8008 denotes an edge detection algorithm used for distribution index values. 8008 is set in conjunction with 8003. Reference numeral 8009 denotes an input field for the size of a filter for smoothing the signal waveform in one line used for distribution index values. Reference numeral 8010 denotes an input field for a threshold value that defines an edge when measurement is carried out by the threshold method. 8010 is set in conjunction with 8005. Reference numeral 8011 denotes a field for selecting the definition of a distribution index value.

Description will be given to the definition of a distribution index value. The field 8011 in FIG. 8 includes the options of <standard deviation>, <specific frequency component>, <sign>, <difference from simulation>, <shrink>, and the like. The calculation method for distribution index value will be described later with respect to each option. Detailed description will be given to the distribution index value of edge positions in the flowchart in FIG. 4.

(1) Distribution Index Value when <Standard Deviation> is Selected

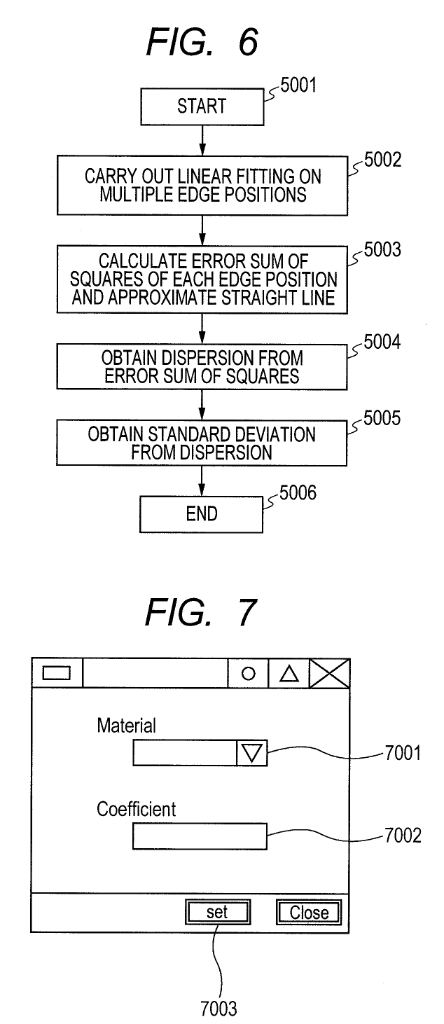

FIG. 6 is a flowchart of distribution index value calculation carried out when <standard deviation> is selected as the distribution index value of edges. In case of the contact hole pattern shown in FIG. 2, the standard deviation of edge positions is determined from the edge positions Edge₁ to Edge_{N} in FIG. 2 and it is taken as the distribution index value. The pattern linewidth of resist transferred by an etching process is calculated from this distribution index value and the above-mentioned edge mean position by the following expression:

CD=E+σ×N Expression (1)

where, CD is a pattern linewidth to be managed; E is the above-mentioned edge mean position determined from multiple edge positions; and σ is a distribution index value. N denotes an arbitrary constant. This constant N is determined by input from a user as shown in the GUI in FIG. 7. Or, it is automatically determined by incorporating material information on the object of observation. That is, N is a parameter that is varied depending on the pattern form, material, or the like of the object of measurement.

The projected portions are corrected by carrying out measurement outside the edge mean position by an amount equivalent to σ as mentioned above. This makes it possible to measure the linewidth of a resist pattern that effectively works during etching.

This index value is a standard deviation based on the science of statistics and a reliable distribution index value calculated by a simple calculation expression.

(2) Distribution Index Value when <Specific Frequency Component> is Selected

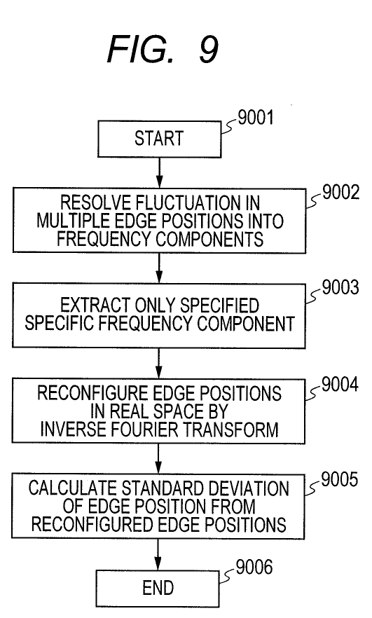

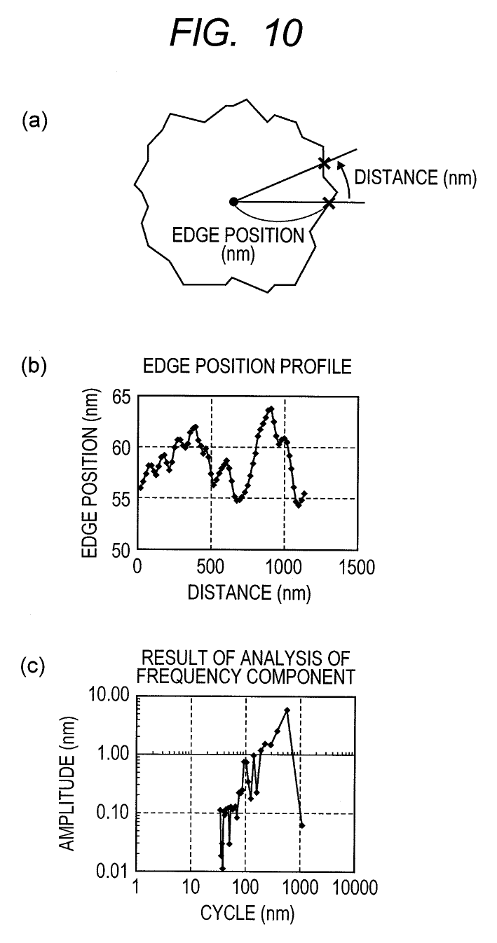

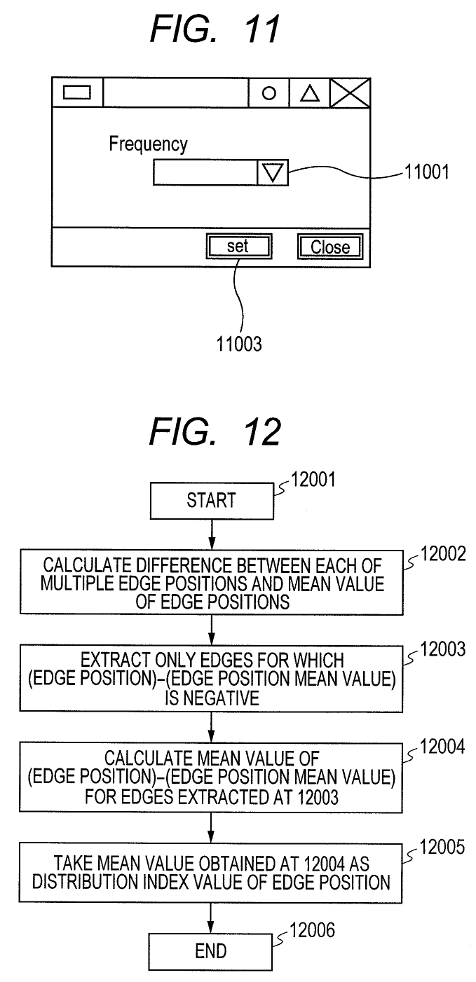

FIG. 9 is a flowchart of distribution index value calculation carried out when <specific frequency component> is selected as the distribution index value of edges. The edge positions Edge₁ to Edge_{N} in FIG. 2 are detected and based on the result of this edge position detection, fluctuation in the edge position of the measured pattern is resolved into frequency components. For this purpose, FFT (Fast Fourier Transform) or DFT (Discrete Fourier Transform) is used. FIG. 9 is a flowchart of this technique. Fluctuation in the multiple detected edge positions is resolved into frequency components using FFT or DFT. FIG. 10 illustrates the result obtained by resolving fluctuation in the edge positions of the contact hole pattern illustrated in FIG. 2 into each frequency component by DFT. In FIG. 10, fluctuation in edge position is resolved into frequency components and the amplitude of each frequency component is plotted. This makes it possible to check how largely the frequency for which observation is to be carried out fluctuate. A frequency component for which observation is to be carried out is selected from among the individual frequency components obtained as illustrated in FIG. 10 using the GUI in FIG. 11. Reference numeral 11001 in FIG. 11 denotes a field for selecting a frequency and a frequency can be selected from among the options of <100 nm or above>, <less than 100 nm>, <π/2 or above>, <less than π/2>, and the like. <100 nm or above> and <less than 100 nm> cited here indicate the length of a cycle in a real space. With the option of <100 nm or above>, for example, a distribution index value is calculated from fluctuations having a cycle of 100 nm or above.

Meanwhile, <π/2 or above> and <less than π/2> specify a method of calculating a distribution index value by limiting an angular frequency. When the button 11003 in FIG. 11 is pressed, the selected frequency is set in the distribution index value setting unit 103. At Step 9004, subsequently, only the selected frequency component is extracted and the edge positions in the frequency space are reconfigured in the real space. At Step 9005, the standard deviation of edge positions is determined from the reconfigured edge positions and it is taken as the distribution index value of edge positions. The thus obtained distribution index value a is substituted into Expression (1) to determine a pattern linewidth.

Use of this index value makes it possible to extract only a frequency component meeting a user's request and carry out more accurate linewidth management.

(3) Distribution Index Value when <Sign> is Selected

FIG. 12 is a flowchart of distribution index value calculation carried out when <sign> is selected as the distribution index value of edges. First, the difference between each of multiple edge positions and the mean value of edge positions is calculated (Step 12002). The values calculated at Step 12002 are obtained by quantitatively calculating the asperities in each edge from an average edge position. In case of depressed edges measured in the invention, (edge position)-(edge position mean value) is positive. At Step 12003, it is determined whether the sign is positive or negative and only edges whose sign is positive are extracted. At Step 12004, subsequently, the average degree of depression of the depressed edges is calculated. The average degree of depression calculated here is taken as the distribution index value and is substituted into a in Expression (1) to measure a pattern linewidth.

In case of this index value, it is just determined whether an edge is projected or depressed and this makes it unnecessary to impose a load on the calculation unit.

(4) Distribution Index Value when <Difference from Simulation> is Selected

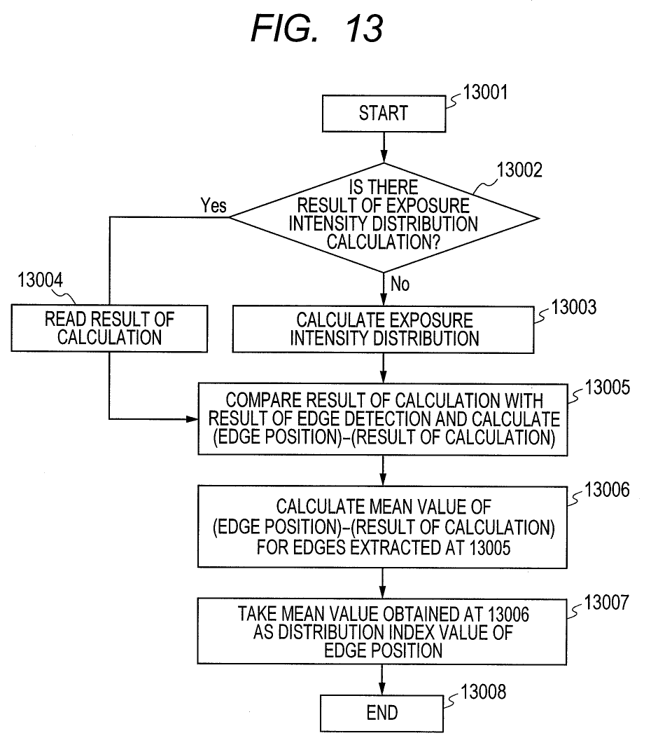

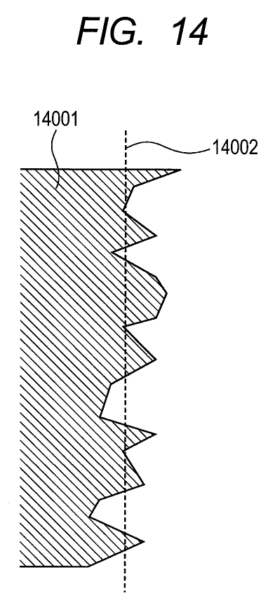

FIG. 13 is a flowchart of distribution index value calculation carried out when <difference from simulation> is selected as the distribution index value of edges. At Step 13002, first, it is determined whether or not an exposure intensity distribution has been calculated before. When it has been calculated before, the flow proceeds to Step 13004 and the result of the calculation is read from the storage unit 11. When it has not been calculated before, an exposure intensity distribution is calculated at Step 13003. FIG. 14 schematically illustrates the result of pattern edge calculation obtained by exposure intensity distribution calculation and an actually detected edge. Reference numeral 14001 denotes a resist pattern and reference numeral 14002 denotes the result of pattern edge calculation obtained from exposure intensity distribution calculation. Subsequently, the obtained result of calculation of exposure intensity distribution and the actually detected edge are compared with each other. (Edge position)-(result of calculation) is calculated and the mean value thereof is calculated at Step 13006. The mean value calculated at Step 13006 is substituted as the distribution index value of edge positions into Expression (1) to determine a pattern linewidth.

In this calculation method for index values, the result of calculation of exposure intensity distribution and an actual pattern are compared with each other; therefore, a reliable value can be obtained.

(5) Distribution Index Value when <Shrink> is Selected

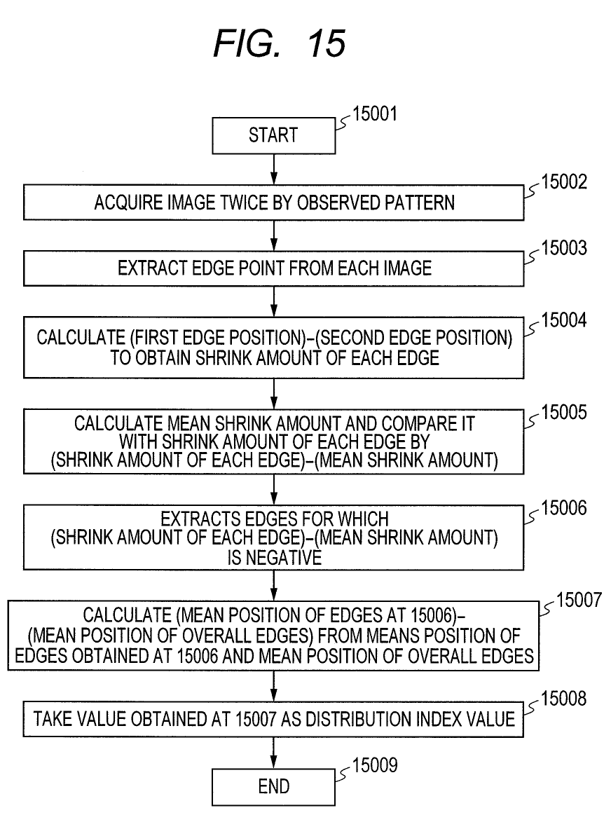

FIG. 15 is a flowchart of distribution index value calculation carried out when <shrink> is selected as the distribution index value of edges. A phenomenon (shrink) that resist is shrunk by electron beam irradiation is known. Also in case of shrink, similarly to etching, projected edges tend to shrink more. Consequently, an identical pattern is observed twice and edges are classified into edge left at the time of etching and edge not left according to the state of shrinkage in each edge. Then a distribution index value is calculated. First, an image is acquired twice from an observed pattern (Step 15002) and edge points are extracted from each image (Step 15003). Subsequently, the difference between an edge position obtained from the first image pickup and an edge position obtained from the second image pickup is calculated to calculate the shrink amount at each edge point (Step 15004). The calculated shrink amount at each edge point and the mean value of the shrink amounts of all the edges are compared with each other (Step 15005). Then edges whose shrink amount is smaller than the average shrink amount are extracted (Step 15006). (Mean position of edges at 15006)-(mean position of overall edges) is calculated from the mean position of the edges extracted at Step 15006 and the mean position of all the edges (Step 15007). The value obtained at Step 15007 is substituted as distribution index value into a in Expression (1) to determine a pattern linewidth.

With respect to this index value, a lost edge is determined from the amount of actual change in form and a reliable value can be obtained.

In this invention, the following measure may be taken: after an edge position is calculated, a brightness profile is calculated again perpendicularly to this edge position to calculate the edge position again. FIG. 18 illustrates brightness profiles obtained when it is generated at an angle to an edge position (a) and obtained when it is generated perpendicularly to the edge position (b). In case of (a), a signal peak used in edge calculation is wide and an error is prone to be produced in edge position determination. In case of (b), meanwhile, a signal peak is in sharp form and it is possible to reduce any error in edge position determination. Use of this technique enables more accurate linewidth measurement than conventional.

### Second Embodiment

In the description of this embodiment, consideration will be given to a case where such a gate pattern as illustrated in FIG. 1 is measured. The same processing as described in relation to the first embodiment is carried out. In this embodiment, however, a gate pattern line breadth is measured and thus resist itself is measured. Since in the first embodiment, the pattern of a hole formed in resist is measured, the positive and negative signs in Expression (1) are inverted. That is, a gate pattern linewidth is measured using:

CD=E−σ×N Expression (2)

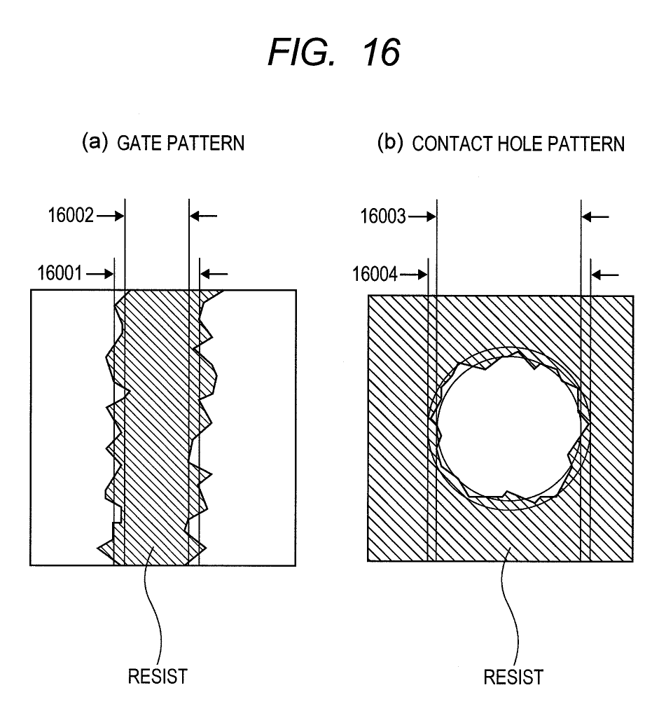

FIG. 16 illustrates the difference between contact hole pattern measurement and gate pattern measurement. Reference numeral 16001 in FIG. 16 denotes a gate pattern line breadth calculated from an average edge position and in this invention, the linewidth of a depressed area indicated by 16002 is measured. Therefore, a pattern linewidth is calculated by the difference in distribution index value between an edge mean position and an edge position as represented by Expression (2). In case of contact hole pattern, meanwhile, reference numeral 16003 denotes a hole diameter calculated from an edge mean position. Reference numeral 16004 denotes the result of linewidth measurement obtained from a depressed edge according to the invention. That is, a pattern linewidth is calculated by the sum of an edge mean position and a distribution index value of edge positions as represented by Expression (1).

In gate pattern measurement, it is necessary to measure a pattern linewidth from two left and right edges. In this invention, a distribution index value may be calculated from either a left edge or a right edge or the following measure may be taken: a distribution index value is separately determined from a left edge and from a right edge and a value obtained by averaging the obtained distribution index values is taken as the total distribution index value.

### Third Embodiment

In this invention, distribution index values are greatly influenced by the accuracy of edge detection. The accuracy of edge detection is determined mainly by the signal-to-noise ratio of each image. As mentioned above, resist material shrinks. Therefore, if it is irradiated with many electron beans, its form largely differs from its original form and accurate dimensional inspection cannot be carried out. To cope with this, the amount and energy of applied electron beams are reduced. However, the signal-to-noise ratio is degraded under this condition and edge detection accuracy is degraded. Since this noise is random noise, in general, a distribution index value obtained from an image inferior in signal-to-noise ratio takes a larger value than the true value. In this invention, to cope with this, the following measure is taken. The signal-to-noise ratio of an image of the object of measurement is calculated. When the result of the calculation is equal to or lower than a signal-to-noise ratio registered beforehand by the user, the calculated distribution index value is multiplied by an arbitrary coefficient not less than 0 and not more than 1. The overestimated distribution index value can be thereby corrected. The value multiplied at the time of this correction is determined by signal-to-noise ratio. The coefficient is determined by referring to a correction table registered beforehand in the storage unit.

### Fourth Embodiment

In the description of the first embodiment to the third embodiment, cases where resist material is mainly observed have been taken as examples. However, the invention is not limited to this. It is applicable also to materials designated as hard mask using silicon oxide material, silicon nitride material, and the like.

### EXPLANATION OF REFERENCE NUMERALS AND SYMBOLS

1—Electron-optics
2—Electron source
3—Condensing lens
4—Deflector
5—Objective lens
6—Stage
7—Observed sample
8—Detector
10—Display unit
11—Storage unit
12—Flow of storing data in storage unit
13—Flow of reading data from storage unit
14—Electron-optics control unit
101—Image memory
102—Pattern form setting unit
103—Distribution index value setting unit
104—Pattern edge detection unit
105—Pattern edge mean position calculation unit
106—Distribution index value calculation unit
107—Pattern inspection index value calculation unit
4001—Linewidth measurement start step
4002—Electron-optics set-up step
4003—Edge number initialization step
4004—Image acquisition step
4005—Brightness profile calculation step
4006—Profile number selection step
4007—Edge position calculation step
4008—Edge position storage step
4009—Edge number determination step
4010—Edge position call step
4011—Edge position mean value calculation step
4012—Edge position distribution index value calculation step
4013—Pattern linewidth calculation step
4014—Display step
4015—Linewidth measurement end step
5001—Start step of distribution index value calculation
5002—Linear fitting step
5003—Error sum of squares calculation step
5004—Dispersion calculation step
5005—Standard deviation calculation step
5006—End step of distribution index value calculation
7001—Input field for material
7002—Input/output field for constant
7003—Constant setting field
8001—Input field for number of measurement points
8002—Input field for number of added pixels
8003—Algorithm selection field
8004—Input field for smoothing filter size
8005—Input field for threshold value
8006—Input field for number of measurement points for distribution index value
8007—Input field for number of added pixels for distribution index value
8008—Algorithm selection field for distribution index value
8009—Input field for smoothing filter size for distribution index value
8010—Input field for threshold value for distribution index value
8011—Input field for distribution index value definition
8012—Measurement parameter setting button
9001—Start step of flow of calculating distribution index value from specific frequency
9002—Frequency decomposition step
9003—Specific frequency component extraction step
9004—Edge reconfiguration step
9005—Distribution index value calculation step
9006—End step
11001—Input field for specific frequency
11003—Specific frequency setting button
12001—Start step of calculation of distribution index value through comparison with edge mean value
12002—Step of comparison of edge mean position with edge position
12003—Edge extraction step
12004—Extracted edge mean value calculation step
12005—Distribution index value calculation step
12006—End step
13001—Start step of calculation of distribution index value from exposure intensity distribution
13002—Step of determining whether or not exposure intensity has been calculated
13003—Exposure intensity distribution calculation step
13004—Calculation result read step
13005—Edge comparison step
13006—Extracted edge mean value calculation step
13007—Distribution index value calculation step
13008—End step
14001—Resist pattern
14002—Exposure intensity distribution result
15001—Start step of calculation of distribution index value from shrink amount
15002—Observation step
15003—Edge extraction step
15004—Shrink amount calculation step
15005—Edge comparison step
15006—Edge extraction step
15007—Difference calculation step
15008—Distribution index value calculation step
15009—End step
16001—Gate pattern edge mean position
16002—Gate pattern edge position calculated according to invention
16003—Contact hole pattern edge mean position
16004—Contact hole pattern edge position calculated according to invention

1. A pattern linewidth measurement method comprising:
scanning and applying an electron beam to an observation area of a sample placed over a stage and detecting a reflection electron or a secondary electron generated from this sample with a detector;
using information on the detected reflection electron intensity or secondary electron intensity to acquire a two-dimensional image of a pattern as the object of linewidth measurement placed in the observation area; and
using the two-dimensional image to detect the edge position of the pattern at a plurality of points in the pattern and thereby measuring the linewidth of the pattern in the observation area, characterized in that there are provided:
specifying a calculation method for the distribution index value of the edge positions detected at the points in the pattern;
calculating a distribution index value corresponding to the specified calculation method;
calculating the mean position of the edges; and
calculating a pattern inspection index value from the calculated mean position of the edges and the distribution index value.

2. The pattern linewidth measurement method according to claim 1, characterized in that:
the distribution index value is the standard deviation of the edge positions; and
the value calculated using Expression (1) is taken as pattern inspection index value:
E±σ×N Expression (1)
where, E is the mean position of the edges; σ is the distribution index value of the edges; and N is an arbitrary constant.

3. The pattern linewidth measurement method according to claim 1, characterized in that:
the distribution index value is the standard deviation of edge positions obtained by carrying out frequency decomposition on the edge positions and carrying out calculation from specific frequency components; and
the value calculated using Expression (2) is taken as pattern inspection index value:
E′±σ′×N′ Expression (2)
where, E′ is the mean position of the edges; σ′ is the distribution index value of the edges; and N′ is an arbitrary constant.

4. The pattern linewidth measurement method according to claim 1, characterized in that:
the distribution index value is the difference between the mean position of the edges and each edge; and
asperities information on edges is determined from the sign of the distribution index value, the mean position of depressed edges is calculated based on the result of the determination, and this calculation result is taken as pattern inspection index value.

5. The pattern linewidth measurement method according to claim 1, characterized in that:
the distribution index value is the difference between pattern form calculated beforehand and the edge position; and
asperities information on edges is determined from the sign of the distribution index value, the mean position of depressed edges is calculated based on the result of the determination, and this calculation result is taken as pattern inspection index value.

6. The pattern linewidth measurement method according to claim 1, characterized in that:
edge positions obtained by measuring an identical point more than once are compared with each other to calculate the amount of change in edge position, and this amount of change in edge position is taken as the distribution index value; and
the mean position of edges the distribution index value of which is smaller than the mean value of distribution index values is calculated and this calculation result is taken as pattern inspection index value.

7. The pattern linewidth measurement method according to claim 1, characterized in that:
a threshold value is set beforehand for the signal-to-noise ratio of the two-dimensional image that determines the accuracy of edge detection, and when the acquired two-dimensional image does not meet this threshold value, the calculated distribution index value is multiplied by an arbitrary constant not more than 1 and this calculation result is taken as distribution index value.

8. The pattern linewidth measurement method according to claim 1, characterized in that:
the arbitrary constant is set from the material of the observed sample.

9. The pattern linewidth measurement method according to claim 1, characterized in that there are provided:
calculating the edge positions;
calculating the intensity distribution of reflection electron or secondary electron in the direction perpendicular to the edge positions; and
recalculating an edge position from the intensity distribution.

10. The pattern linewidth measurement method according to claim 1, characterized in that:
the intensity distribution of reflection electron or secondary electron is calculated in the direction perpendicular to the edge positions; and
an edge position is calculated again from the calculated intensity distribution.

11. A scanning electron microscope comprising:
a detector scanning and applying an electron beam to an observation area of a sample placed over a stage and detecting a reflection electron or a secondary electron generated from this sample;
means that uses information on the reflection electron intensity or secondary electron intensity detected at the detector to acquire a two-dimensional image of a pattern as the object of linewidth measurement placed in the observation area; and
means that uses the two-dimensional image to detect the edge position of the pattern as the object of linewidth measurement placed in the observation area at a plurality of points in the pattern and thereby measuring the linewidth of the pattern in the observation area, characterized in that there are provided:
a calculation unit carrying out calculation based on information inputted from the scanning electron microscope or a display unit;
the display unit displaying information inputted to the calculation unit or the result of calculation at the calculation unit; and
a storage unit holding the result of calculation at the calculation unit or information supplied to the calculation unit; and
the calculation unit includes:
a pattern edge mean position calculation unit calculating the mean position of edges of the pattern detected at a plurality of points;
a distribution index value calculation unit calculating a distribution index value determined according to a calculation method selected from among calculation methods for the distribution index value of the edge positions displayed on the display unit; and
a pattern inspection index value calculation unit calculating a pattern inspection index value based on the calculated mean position of the edges and the distribution index value.

12. The scanning electron microscope according to claim 11, characterized in that:
the calculated pattern inspection index value is displayed on the display unit.

13. The scanning electron microscope according to claim 11, characterized in that there are further provided:
a control system issuing an instruction to apply the electron beam to a pattern as the object of linewidth measurement more than once;
an image memory acquiring a plurality of observed images resulting from the irradiation of the electron beam; and
an edge detection unit reading any two images from the observed images stored in the storage unit, detecting edges from each of the two read images, and comparing detected edges with each other.

14. The scanning electron microscope according to claim 11, characterized in that:
there is further provided means that sets a threshold value beforehand for the signal-to-noise ratio of the two-dimensional image that determines the accuracy of edge detection;
when the acquired two-dimensional image does not meet this threshold value, the calculated distribution index value is multiplied by an arbitrary constant not more than 1; and
the result of this multiplication is displayed as distribution index value on the display unit.
